(19) United States
(12) Patent Application Publication
(10) Pub. No.: US 2025/0326606 A1
(43) Pub. Date: Oct. 23, 2025

(54) SYSTEM AND METHOD OF OPERATING AN ELEVATOR SYSTEM TO SELECT AN ELEVATOR CAR OF A BANK OF ELEVATOR CARS FROM AN ELEVATOR HEALTH AND USAGE STATE AND A TRAVEL TIME TO RESPOND TO A SERVICE REQUEST

(71) Applicant: OTIS ELEVATOR COMPANY, Farmington, CT (US)

(72) Inventors: Arthur Hsu, South Glastonbury, CT (US); Srinivasarao Ladi, Hyderabad Telangana (IN); Buddanna Telugu, Hyderabad (IN)

(21) Appl. No.: 18/639,462

(22) Filed: Apr. 18, 2024

(51) Int. Cl. B66B 1/20; B66B 5/00

(52) U.S. Cl. CPC B66B 1/20; B66B 5/0025; B66B 2201/212; B66B 2201/22; B66B 2201/222

(57) ABSTRACT

An elevator system in a building having a plurality of levels, the system having elevator cars, a controller operationally coupled to the elevator cars, and configured to receive a service request, and render a first determination to select one of the elevator cars to respond to the service request, wherein the controller is configured to render the first determination from a determination of one or more of an elevator health and usage state of the elevator cars, and a travel time to respond to the service request by each of the elevator cars.

### BACKGROUND

The embodiments described herein relate to an elevator system and more specifically to a system and method of operating an elevator system to select an elevator car of a bank of elevator cars from an elevator health and usage state and a travel time to respond to a service request.

A dispatcher may assign cars based on traffic performance objectives without regard to the condition status or component usage of each car. This may result in undesired wearing of elevator car components.

### BRIEF SUMMARY

An elevator system in a building having a plurality of levels, the system including elevator cars, a controller operationally coupled to the elevator cars, and configured to receive a service request, and render a first determination to select one of the elevator cars to respond to the service request, wherein the controller is configured to render the first determination from a determination of one or more of an elevator health and usage state of the elevator cars, and a travel time to respond to the service request by each of the elevator cars.

In addition to one or more aspects of the system or as an alternate the controller determines the travel time for each of the elevator cars by utilizing one or more travel time factors, including one or more of: a current car position of each of the elevator cars; a direction of motion of each of the elevator cars; a door open and closed state of each of the elevator cars; a number of intermediate stops assigned to each of the elevator cars; and a number of calls assigned to each of the elevator cars and a number of passengers served by each of the elevator cars.

In addition to one or more aspects of the system or as an alternate the controller determines the elevator health and usage state of the elevator cars by utilizing one or more health and usage factors, including a health index and diagnostic information, and including one or more of: a number of times elevator doors have opened and closed for each of the elevator cars; accumulated bends per segment of elevator tension members around elevator sheaves; a charge state and health of on-board batteries for each of the elevator cars; energy utilization from operation of each of the elevator cars; an operating temperature of elevator components for each of the elevator cars; a number of machine starts of the elevator machines for each of the elevator cars; maintenance records for each of the elevator cars; a remaining lifespan of components of each of the elevator cars, including one or more of ropes and belts attached to each of the elevator cars; and ride quality for each of the elevator cars, including noise and vibration.

In addition to one or more aspects of the system or as an alternate the controller is configured to: apply weighting to the health and usage factors, including the health index and diagnostic information, to determine a score for each of the elevator cars; and select the one of the elevator cars to respond to the service request from the score determined for each of the elevator cars.

In addition to one or more aspects of the system or as an alternate the controller is configured to: control an ongoing operation of the elevator cars from the score determined for each of the elevator cars, which includes one or more of: utilizing the elevator cars to balance the health and usage scores for each elevator car; reducing a utilization or speed of one or more of the elevator cars when the score is above a threshold; or increasing the usage of one or more of the elevator cars when the score is above the threshold.

In addition to one or more aspects of the system or as an alternate the system includes sensors, located on one or more of the elevator cars and elevator machines, operationally coupled to the controller and configured to capture sensor data during operation of the elevator cars and machines and transmit the sensor data to the controller, wherein the controller is configured to utilize the sensor data when analyzing the elevator health and usage state for the elevator cars.

In addition to one or more aspects of the system or as an alternate upon completing the service request by the one of the elevator cars, the controller is configured to update the elevator health and usage state for the one of the elevator cars.

In addition to one or more aspects of the system or as an alternate following maintenance of the elevator cars, the controller is configured to update the elevator health and usage state for the elevator cars.

In addition to one or more aspects of the system or as an alternate: the controller renders the first determination from the travel time to respond to the service request; and upon the controller determining that the elevator cars will respond to the service request within a same period of time, the controller is configured to render a second determination to select the one of the elevator cars to respond to the service request; and the controller is configured to render the second determination from the elevator health and usage state.

In addition to one or more aspects of the system or as an alternate: upon the controller determining that the elevator health and usage state are the same for each of the elevator cars, the controller is configured to render a third decision to select the one of the elevator cars to respond to the service request from a round-robin sequence assigned to the elevator cars.

A method of operation an elevator system in a building having elevator cars, a controller operationally coupled to the elevator cars, and a plurality of levels serviced by the elevator cars, the method including the controller: receiving a service request; and rendering a first determination to select one of the elevator cars to respond to the service request, wherein the first determination includes the controller determining one or more of an elevator health and usage state of the elevator cars, and a travel time to respond to the service request for each of the elevator cars.

In addition to one or more aspects of the method or as an alternate the method includes the controller determining the travel time for each of the elevator cars by utilizing one or more travel time factors, including one or more of: a current car position of each of the elevator cars; a direction of motion of each of the elevator cars; a door open and closed state of each of the elevator cars; a number of intermediate stops assigned to each of the elevator cars; and a number of calls assigned to each of the elevator cars and a number of passengers served by each of the elevator cars.

In addition to one or more aspects of the method or as an alternate the method includes the controller determining the elevator health and usage state of the elevator cars by utilizing one or more health and usage factors, including a health index and diagnostic information, including one or more of: a number of times elevator doors have opened and closed for each of the elevator cars; accumulated bends per segment of elevator tension members around elevator sheaves; a charge state and health of on-board batteries for each of the elevator cars; energy utilization from operation of each of the elevator cars; an operating temperature of elevator components for each of the elevator cars; a number of machine starts of the elevator machines for each of the elevator cars; maintenance records for each of the elevator cars; a remaining lifespan of components of each of the elevator cars, including the tension members attached to each of the elevator cars; and ride quality for each of the elevator cars, including noise and vibration.

In addition to one or more aspects of the method or as an alternate the method includes the controller: applying a weighting to the health and usage factors, including the health index and diagnostic information, to determine a score for each of the elevator cars; and selecting the one of the elevator cars to respond to the service request from the score determined for each of the elevator cars.

In addition to one or more aspects of the method or as an alternate the method includes the controller: controlling an ongoing operation of the elevator cars from the score determined for each of the elevator cars, which includes one or more of: utilizing the elevator cars to balance the health and usage scores for each elevator car; reducing a utilization or speed of one or more of the elevator cars when the score is above a first threshold; or increasing the usage of one or more of the elevator cars when the score is above a second threshold.

In addition to one or more aspects of the method or as an alternate: sensors are located on one or more of the elevator cars and elevator machines, operationally coupled to the controller and configured to capture sensor data during operation of the elevator cars and machines and transmit the sensor data to the controller, and the method includes the controller utilizing the sensor data when analyzing the elevator health and usage state for the elevator cars.

In addition to one or more aspects of the method or as an alternate upon completing the service request by the one of the elevator cars, the method includes the controller updating the elevator health and usage state for the one of the elevator cars.

In addition to one or more aspects of the method or as an alternate following maintenance of the elevator cars, the method includes the controller updating the elevator health and usage state for the elevator cars.

In addition to one or more aspects of the method or as an alternate the method includes the controller: rendering the first determination from the travel time to respond to the service request; and determining that the elevator cars will respond to the service request within a same period of time, and rendering a second determination to select the one of the elevator cars to respond to the service request; and rendering the second determination from the elevator health and usage state.

In addition to one or more aspects of the method or as an alternate the method includes the controller: determining that the elevator health and usage state are the same for each of the elevator cars; and rendering a third decision to select the one of the elevator cars to respond to the service request from a round-robin sequence assigned to the elevator cars.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 shows additional aspects of the elevator system, which is configured to select an elevator car of a bank of elevator cars from an elevator health and usage state and a travel time to respond to a service request; and

FIG. 3 is a flowchart showing a method of operating an elevator system to select an elevator car of a bank of elevator cars from an elevator health and usage state and a travel time to respond to the service request.

### DETAILED DESCRIPTION

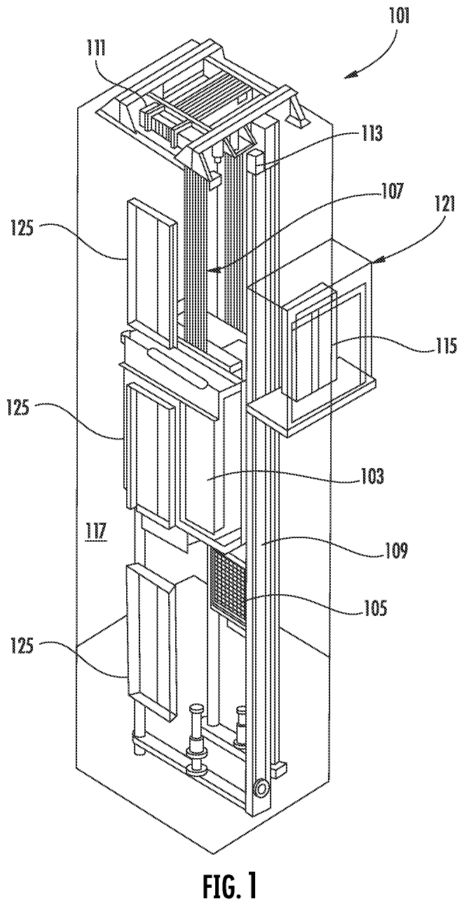

FIG. 1 is a perspective view of an elevator system 101 including an elevator car 103, a counterweight 105, a tension member 107, a guide rail (or rail system) 109, a machine (or machine system) 111, a position reference system 113, and an electronic elevator controller (controller) 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft (or hoistway) 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 may be located, as shown, in a controller room 121 of the elevator shaft 117 and is configured to control the operation of the elevator system 101, and particularly the elevator car 103. It is to be appreciated that the controller 115 need not be in the controller room 121 but may be in the hoistway or other location in the elevator system. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. Embodiments may also be employed in ropeless elevator systems using self-propelled elevator cars (e.g., elevator cars equipped with friction wheels, pinch wheels or traction wheels). FIG. 1 is merely a non-limiting example presented for illustrative and explanatory purposes.

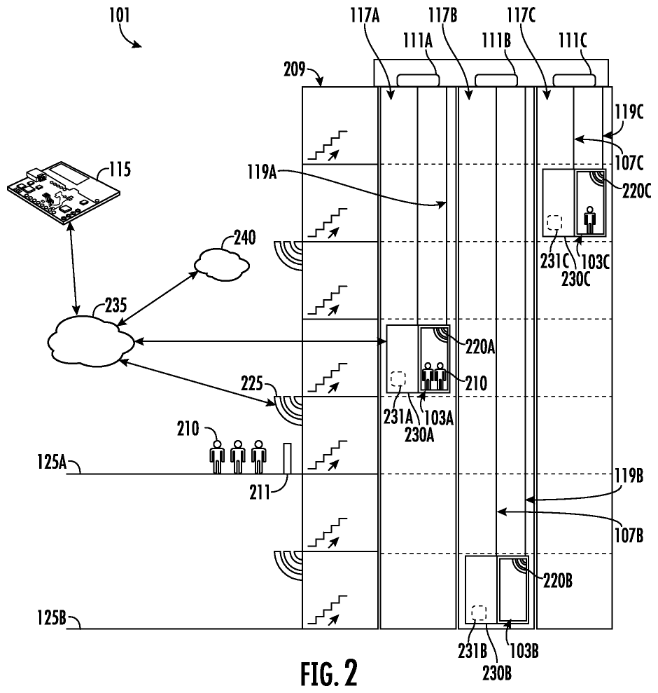

Turning to FIG. 2, additional aspects of the system 110 of FIG. 1 are shown. Within a building 209, the system 101 may have elevator shafts 117A-117C. Within the shafts 117A-117C, a bank of cars 103A-103C are driven by machines 111A-111C via belts 107A-107C to move passengers 210 between floors 125. The passengers 210 may utilize a call station 211 on a first level 125A to request service for transportation to a second level 125B. The cars 103A-103C may be powered, and may communicate with the controller 115, via traveling and hoistway cables (for simplicity, cables) 119A-119C and onboard batteries 231A-231C. The cars 103A-103C may also communicate wirelessly over a network 235, which may include a cloud service 240, with the controller 115 via communication access points 225. The cars 103A-103B have doors 230A-230C and sensors 220A-220B, which may communicate via wired or wireless communications with the controller 115. The sensors 220A-220B may sense velocity, acceleration, vibration, of the cars 103A-103B, which may be generated by motion of the cars 103A-103C and operation of the doors 230A-230C. From these communications, the controller 115 may track the health of the cars 103A-103C.

According to the embodiments, the controller 115 is configured to receive a service request, e.g., via the call station 211. To make a dispatch decision, the controller 115 is configured to render a first determination to select one of the elevator cars 103A-103C to respond to the service request. The controller 115 renders the first determination from a determination of one or more of elevator health and usage state of the elevator cars 103A-103C, and a travel time to respond to the service request for each of the elevator cars elevator cars 103A-103C.

The controller determines the travel response time for each of the elevator cars 103A-130C by utilizing one or more travel time factors. The travel time factors include one or more of (i) a current car position of each of the elevator cars 103A-103C; (ii) a direction of motion of each of the elevator cars 103A-103C; (iii) a door open and closed state of each of the elevator cars 103A-103C; (iv) a number of intermediate stops assigned to each of the elevator cars 103A-103C; and (v) a number of calls assigned to each of the elevator cars and a number of passengers (e.g., counted by people counting sensors) served by each of the elevator cars.

For example, the first elevator car 103A, nearer the call floor 125A compared with the second elevator car 130B, may not be selected over the second elevator car 103B for various reasons. For example if the first elevator car 103A has its doors 230A open, it could be loading and unloading passengers 210, which may be time consuming. The second elevator car 103B that is a bit further away may have its doors 230B closed, indicating it is ready to make the service call. If the second and third cars 103B, 103C are separated by a same distance from the call floor 125A, the second car 103B may be selected over the third car 103C for various reasons. For example, if the third car 103C is moving away from the call floor 125A and the second car 103B is moving toward the call floor 125A or is stationary, the second car 103B may more quickly respond to the service call. Similarly if the first and third elevator cars 103A, 103C have scheduled intermediate stops, and the second car 103B does not or has fewer scheduled stops, the second car 103B may be selected because it would respond more quickly to the service call.

The controller 115 determines the elevator health and usage state of the elevator cars 103A-103C by utilizing one or more health and usage factors, including a health index and diagnostic information. The health and usage factors, including the health index and diagnostic information, include one or more of: (i) a number of times (cycles) the doors 230A-230C have opened and closed for each of the elevator cars 103A-103C; (ii) accumulated bends per segment of the belts or ropes (collectively tension members) 107A-107B, e.g., around the elevator machines 111A-111B; (iii) a charge state and health of on-board batteries 231A-231C for each of the elevator cars 103A-103C; (iv) energy utilization from operation of each of the elevator cars 103A-103C; (v) an operating temperature of the elevator machines, drives, brakes, etc. (generally referred to as elevator components) for each of the elevator cars 103A-103C (e.g., as measured via a temperature sensor including but not limited to a thermocouple or thermometer); (vi) a number of machine starts of the elevator machines for each of the elevator cars 103A-103C; (vii) maintenance records for each of the elevator cars 103A-103C; (viii) a remaining lifespan of components of each of the elevator cars 103A-103C, including the tension members attached to each of the elevator cars 103A-103C; and (ix) ride quality for each of the elevator cars 103A-103C, including noise and vibration.

In one embodiment, the controller 115 is configured to apply weighting to the health and usage factors, including the health index and diagnostic information, to determine a score for each of the elevator cars 103A-103C. The controller is configured to select the one of the elevator cars 103A-103C to respond to the service request from the score determined for each of the elevator cars 103A-103C. The controller 115 may select to utilize an elevator car with a lower overall score.

In one embodiment, the controller 115 is configured to control an ongoing operation of the elevator cars 103A-103C from the score determined for each of the elevator cars 103A-103C. For example, such control would continue after servicing the current service request. For example, the impact of drained batteries may be significant such that the weighting applied to that factor may be relatively large. Similarly, if a car has poor ride quality, the controller 115 may apply relatively large weighting to that factor.

In one embodiment, the controller 115 utilizing the elevator cars 103A-103C to balance the health and usage scores for each elevator as much as possible. This processes may be executed so that the elevator cars 103A-103C have a same useful life. In one embodiment, the controller 115 may reduce a utilization of one or more of the elevator cars 103A-103C when the score is above a threshold. This processes may be executed to reduce operating thermal conditions and prolong a remaining useful life of the one or more of the elevator cars 103A-103C. In one embodiment the controller 115 may increase the usage of one or more of the elevator cars 103A-103C when the score is above a threshold. This process may be executed to reduce a remaining useful life of the one or more of the elevator cars 103A-103C, or fast-track maintenance issues. For example, it may be desirable to replace an aging one of the elevator cars 103A-103C rather than having to replace all cars 103A-103C together. In addition, it may be desirable to bring several elevator cars to the end of life together so they can be replaced/serviced in a single maintenance visit, rather than being serviced one at a time.

Upon completing the service request by the one of the elevator cars 103A-103C, the controller 115 may be configured to update the elevator health and usage state for the one of the elevator cars 103A-103C. Similarly, following maintenance of the elevator cars 103A-103C, the controller 115 is configured to update the elevator health and usage state for the elevator cars 103A-103C. This way, the controller 115 is constantly able to make accurate decisions on controlling the elevator cars 103A-103C.

In one embodiment, the controller 115 renders the first determination from an anticipated travel time of each of the elevator cars 103A-103C to respond to the service request. If the controller 115 determines that the elevator cars 103A-103C will respond to the service request within a same period of time, the controller 115 renders a second determination. Under the second decision, the controller 115 selects the one of the elevator cars 103A-103C to respond to the service request.

The controller 115 renders the second determination from the elevator health and usage state. If the controller 115 determines that the elevator health state and usage state are the same for each of the elevator cars 103A-103C, the controller 115 renders a third decision. Per the third decision, the controller 115 selects the one of the elevator cars 103A-103C to respond to the service request from a round-robin sequence assigned to the elevator cars 103A-103C. As a result, a hindmost (furthest back) utilized one of the elevator cars 103A-103C becomes a next used one of the elevator cars 103A-103C.

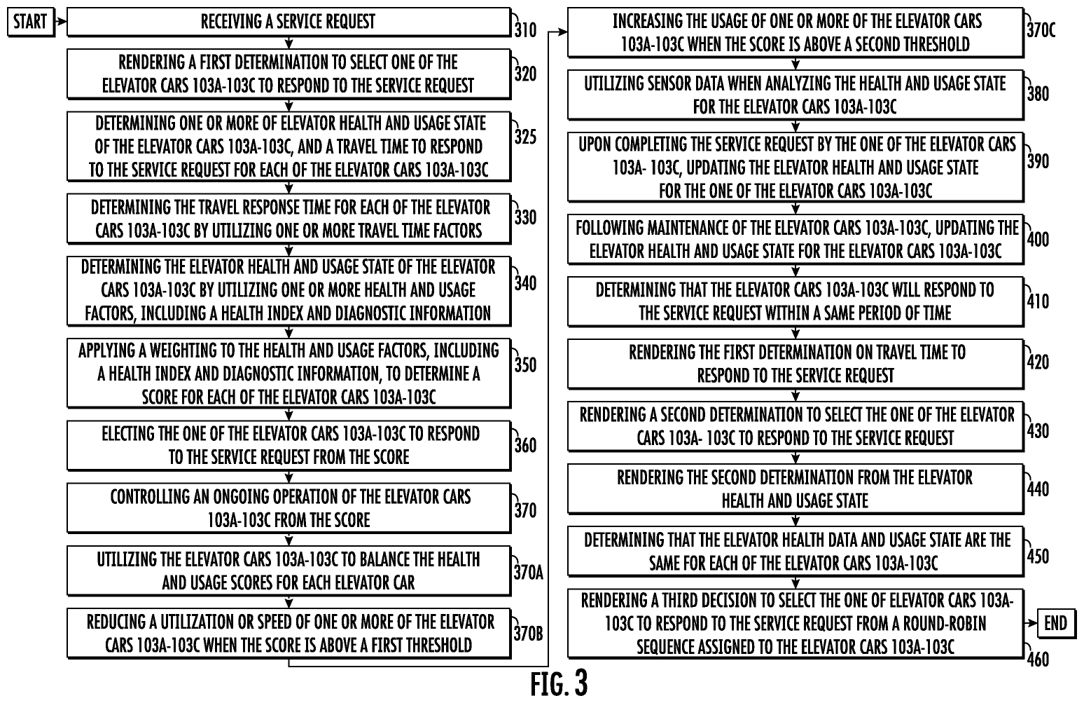

Turning to FIG. 3, a flowchart shows a method of operation the elevator system 101 by the controller 115 according of the above disclosed embodiments.

As shown in block 310, the method includes the controller 115 receiving a service request.

As shown in block 320 the method includes the controller 115 rendering a first determination to select one of the elevator cars 103A-103C to respond to the service request.

As shown in block 325, for the first determination (block 320), the method includes the controller 115 determining one or more of elevator health and usage state of the elevator cars 103A-103C, and a travel time to respond to the service request for each of the elevator cars 103A-103C.

As shown in block 330, the method includes the controller 115 determining the travel response time for each of the elevator cars 103A-103C by utilizing one or more travel time factors. As indicated the factors include one or more of: (i) a current car position of each of the elevator cars 103A-103C; (ii) a direction of motion of each of the elevator cars 103A-103C; (iii) a door open and closed state of each of the elevator cars 103A-103C; (iv) a number of intermediate stops assigned to each of the elevator cars 103A-103C; and (v) and a number of calls assigned to each of the elevator cars and a number of passengers (e.g., counted by people counting sensors) served by each of the elevator cars.

As shown in block 340, the method includes the controller 115 determining the elevator health and usage state of the elevator cars 103A-103C by utilizing one or more health and usage factors, including a health index and diagnostic information. As indicated, these factures include one or more of: (i) a number of times the doors have opened and closed for each of the elevator cars 103A-103C; (ii) accumulated bends per segment of the tension members 107A-107C around sheaves including but not limited to sheaves of the elevator machines 111A-111C; (iii) a charge state and health of on-board batteries for each of the elevator cars 103A-103C; (iv) energy utilization from operation of each of the elevator cars 103A-103C; (v) an operating temperature of the elevator machines, drives, brakes, etc. (generally referred to as elevator components) for each of the elevator cars 103A-103C; (vi) a number of machine starts of the elevator machines for each of the elevator cars 103A-103C; (vii) maintenance records for each of the elevator cars 103A-103C; (viii) a remaining lifespan of components of each of the elevator cars 103A-103C, including one or more of ropes and belts attached to each of the elevator cars 103A-103C; and (ix) ride quality for each of the elevator cars 103A-103C, including noise and vibration.

As shown in block 350, the method includes the controller 115 applying a weighting to the health and usage factors to determine a score for each of the elevator cars 103A-103C. As shown in block 360, the method includes the controller 115 selecting the one of the elevator cars 103A-103C to respond to the service request from the score determined for each of the elevator cars 103A-103C.

As shown in block 370, the method includes the controller 115 controlling an ongoing operation of the elevator cars 103A-103C from the score determined for each of the elevator cars 103A-103C. As shown in block 370A, when utilizing the scores (block 370), the method includes the controller 115 utilizing the elevator cars 103A-103C to balance the health and usage scores for each elevator as much as possible. This may be performed so that the elevator cars 103A-103C last as long as each other. Alternatively, as shown in block 370B, when utilizing the scores (block 370), the method includes the controller 115 reducing a utilization or speed of one or more of the elevator cars 103A-103C when the score is above a first threshold. This may be performed to reduce operating thermal conditions and prolong a remaining useful life of the one or more of the elevator cars 103A-103C. Alternatively, as shown in block 370C, when utilizing the scores (block 370), the method includes the controller 115 increasing the usage of one or more of the elevator cars 103A-103C when the score is above a second threshold. This may be performed to reduce a remaining useful life of the one or more of the elevator cars 103A-103C, or fast-track maintenance issues.

As shown in block 380, the method includes the controller 115 utilizing sensor data when analyzing the health and usage state for the elevator cars 103A-103C. As shown in block 390, the method includes the controller 115, upon completing the service request by the one of the elevator cars 103A-103C, updating the elevator health and usage state for the one of the elevator cars 103A-103C. As shown in block 400, the method includes the controller 115, following maintenance of the elevator cars 103A-103C, updating the elevator health and usage state for the elevator cars 103A-103C.

As shown in block 410, the method includes the controller 115 rendering the first determination on travel time to respond to the service request. As shown in block 420, the method includes the controller 115 determining that the elevator cars 103A-103C will respond to the service request within a same period of time. As shown in block 430, the method includes the controller 115 rendering a second determination to select the one of the elevator cars 103A-103C to respond to the service request. As shown in block 440, the method includes the controller 115 rendering the second determination from the elevator health and usage state. As shown in block 450, the method includes the controller 115 determining that the elevator health state and usage state are the same for each of the elevator cars 103A-103C. As shown in block 460, the method includes the controller 115 rendering a third decision to select the one of the elevator cars 103A-103C to respond to the service request from a round-robin sequence assigned to the elevator cars 103A-103C.

With the above embodiments, condition status and/or component usage data are considered in the objective for the dispatching decision. The embodiments provide for the inclusion of non-traffic related objectives considered by the dispatcher in assigning a call to car, such as each car's condition status and/or component usage information. Examples of the car's condition status include the thermal condition of the car. Oftentimes, a machine/drive will reach its thermal limit and be forced to shut down until sufficiently cool. The factors include stored energy status, in the case when a battery needs to be charged sufficiently, and a condition-based health score. The embodiments de-prioritize the assignment of a car when its condition status is relatively poor. Examples of usage information besides the travelling distance include: number of machine starts, number of door cycles, remaining life of a rope/belt according to a model (e.g., by number of bends), etc. The usage information for each component also includes a reset of data when the component is replaced or serviced.

The embodiments provide for adjusting operating parameters of the assigned car, e.g., run at reduced speed, based on the car's condition, e.g., close to thermal limit. The embodiments provide for balancing a remaining life among the cars in the group, and for deliberately using-up a remaining life on cars that will imminently be serviced.

The embodiments also provide for assigning an elevator car that has less travel distance to increase the service time or increase customer satisfaction as a good ride possible. If all elevators in the bank are required to travel a same distance, then a health state or a round-robin utilization scheme can be utilized.

Sensor data identified herein may be obtained and processed separately, or simultaneously and stitched together, or a combination thereof, and may be processed in a raw or complied form. The sensor data may be processed on the sensor (e.g. via edge computing), by controllers identified or implicated herein, on a cloud service, or by a combination of one or more of these computing systems. The senor may communicate the data via wired or wireless transmission lines, applying one or more protocols as indicated below.

Wireless connections may apply protocols that include local area network (LAN, or WLAN for wireless LAN) protocols. LAN protocols include WiFi technology, based on the Section 802.11 standards from the Institute of Electrical and Electronics Engineers (IEEE). Other applicable protocols include Low Power WAN (LPWAN), which is a wireless wide area network (WAN) designed to allow long-range communications at a low bit rates, to enable end devices to operate for extended periods of time (years) using battery power. Long Range WAN (LoRaWAN) is one type of LPWAN maintained by the LoRa Alliance, and is a media access control (MAC) layer protocol for transferring management and application messages between a network server and application server, respectively. LAN and WAN protocols may be generally considered TCP/IP protocols (transmission control protocol/Internet protocol), used to govern the connection of computer systems to the Internet. Wireless connections may also apply protocols that include private area network (PAN) protocols. PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the IEEE, representing a suite of high-level communication protocols used to create personal area networks with small, low-power digital radios for low-power low-bandwidth needs. Such protocols also include Z-Wave, which is a wireless communications protocol supported by the Z-Wave Alliance that uses a mesh network, applying low-energy radio waves to communicate between devices such as appliances, allowing for wireless control of the same.

Wireless connections may also include radio-frequency identification (RFID) technology, used for communicating with an integrated chip (IC), e.g., on an RFID smartcard. In addition, Sub-1 Ghz RF equipment operates in the ISM (industrial, scientific and medical) spectrum bands below Sub 1 Ghz—typically in the 769-935 MHz, 315 Mhz and the 468 Mhz frequency range. This spectrum band below 1 Ghz is particularly useful for RF IoT (internet of things) applications. The Internet of things (IoT) describes the network of physical objects—“things”—that are embedded with sensors, software, and other technologies for the purpose of connecting and exchanging data with other devices and systems over the Internet. Other LPWAN-IoT technologies include narrowband internet of things (NB-IoT) and Category M1 internet of things (Cat M1-IoT). Wireless communications for the disclosed systems may include cellular, e.g. 2G/3G/4G (etc.). Other wireless platforms based on RFID technologies include Near-Field-Communication (NFC), which is a set of communication protocols for low-speed communications, e.g., to exchange date between electronic devices over a short distance. NFC standards are defined by the ISO/IEC (defined below), the NFC Forum and the GSMA (Global System for Mobile Communications) group. The above is not intended on limiting the scope of applicable wireless technologies.

Wired connections may include connections (cables/interfaces) under RS (recommended standard)-422, also known as the TIA/EIA-422, which is a technical standard supported by the Telecommunications Industry Association (TIA) and which originated by the Electronic Industries Alliance (EIA) that specifies electrical characteristics of a digital signaling circuit. Wired connections may also include (cables/interfaces) under the RS-232 standard for serial communication transmission of data, which formally defines signals connecting between a DTE (data terminal equipment) such as a computer terminal, and a DCE (data circuit-terminating equipment or data communication equipment), such as a modem. Wired connections may also include connections (cables/interfaces) under the Modbus serial communications protocol, managed by the Modbus Organization. Modbus is a master/slave protocol designed for use with its programmable logic controllers (PLCs) and is which a commonly available means of connecting industrial electronic devices. Wireless connections may also include connectors (cables/interfaces) under the PROFibus (Process Field Bus) standard managed by PROFIBUS & PROFINET International (PI). PROFibus which is a standard for fieldbus communication in automation technology, openly published as part of IEC (International Electrotechnical Commission) 61158. Wired communications may also be over a Controller Area Network (CAN) bus. A CAN is a vehicle bus standard that allow microcontrollers and devices to communicate with each other in applications without a host computer. CAN is a message-based protocol released by the International Organization for Standards (ISO). The above is not intended on limiting the scope of applicable wired technologies.

When data is transmitted over a network between end processors as identified herein, the data may be transmitted in raw form or may be processed in whole or part at any one of the end processors or an intermediate processor, e.g., at a cloud service (e.g. where at least a portion of the transmission path is wireless) or other processor. The data may be parsed at any one of the processors, partially or completely processed or complied, and may then be stitched together or maintained as separate packets of information. Each processor or controller identified herein may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory identified herein may be but is not limited to a random access memory (RAM), read only memory (ROM), or other electronic, optical, magnetic or any other computer readable medium.

The controller may further include, in addition to a processor and non-volatile memory, one or more input and/or output (I/O) device interface(s) that are communicatively coupled via an onboard (local) interface to communicate among other devices. The onboard interface may include, for example but not limited to, an onboard system bus, including a control bus (for inter-device communications), an address bus (for physical addressing) and a data bus (for transferring data). That is, the system bus may enable the electronic communications between the processor, memory and I/O connections. The I/O connections may also include wired connections and/or wireless connections identified herein. The onboard interface may have additional elements, which are omitted for simplicity, such as controllers, buffers (caches), drivers, repeaters, and receivers to enable electronic communications. The memory may execute programs, access data, or lookup charts, or a combination of each, in furtherance of its processing, all of which may be stored in advance or received during execution of its processes by other computing devices, e.g., via a cloud service or other network connection identified herein with other processors.

Embodiments can be in the form of processor-implemented processes and devices for practicing those processes, such as processor. Embodiments can also be in the form of computer code based modules, e.g., computer program code (e.g., computer program product) containing instructions embodied in tangible media (e.g., non-transitory computer readable medium), such as floppy diskettes, CD ROMs, hard drives, on processor registers as firmware, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes a device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator system in a building having a plurality of levels, the system comprising:
elevator cars;
a controller operationally coupled to the elevator cars, and configured to:
receive a service request; and
render a first determination to select one of the elevator cars to respond to the service request,
wherein the controller is configured to render the first determination from a determination of one or more of an elevator health and usage state of the elevator cars, and a travel time to respond to the service request by each of the elevator cars.

2. The system of claim 1, wherein
the controller determines the travel time for each of the elevator cars by utilizing one or more travel time factors, including one or more of:
a current car position of each of the elevator cars;
a direction of motion of each of the elevator cars;
a door open and closed state of each of the elevator cars;
a number of intermediate stops assigned to each of the elevator cars; and
a number of calls assigned to each of the elevator cars and a number of passengers served by each of the elevator cars.

3. The system of claim 1, wherein
the controller determines the elevator health and usage state of the elevator cars by utilizing one or more health and usage factors, including a health index and diagnostic information, and including one or more of:
a number of times elevator doors have opened and closed for each of the elevator cars;
accumulated bends per segment of elevator tension members around elevator sheaves;
a charge state and health of on-board batteries for each of the elevator cars;
energy utilization from operation of each of the elevator cars;
an operating temperature of elevator components for each of the elevator cars;
a number of machine starts of the elevator machines for each of the elevator cars;
maintenance records for each of the elevator cars;
a remaining lifespan of components of each of the elevator cars, including one or more of ropes and belts attached to each of the elevator cars; and
ride quality for each of the elevator cars, including noise and vibration.

4. The system of claim 3, wherein
the controller is configured to:
apply weighting to the health and usage factors, including the health index and diagnostic information, to determine a score for each of the elevator cars; and
select the one of the elevator cars to respond to the service request from the score determined for each of the elevator cars.

5. The system of claim 4, wherein
the controller is configured to:
control an ongoing operation of the elevator cars from the score determined for each of the elevator cars, which includes one or more of:
utilizing the elevator cars to balance the health and usage scores for each elevator car;
reducing a utilization or speed of one or more of the elevator cars when the score is above a threshold; or
increasing the usage of one or more of the elevator cars when the score is above the threshold.

6. The system of claim 1, comprising
sensors, located on one or more of the elevator cars and elevator machines, operationally coupled to the controller and configured to capture sensor data during operation of the elevator cars and machines and transmit the sensor data to the controller,
wherein the controller is configured to utilize the sensor data when analyzing the elevator health and usage state for the elevator cars.

7. The system of claim 1, wherein
upon completing the service request by the one of the elevator cars, the controller is configured to update the elevator health and usage state for the one of the elevator cars.

8. The system of claim 1, wherein
following maintenance of the elevator cars, the controller is configured to update the elevator health and usage state for the elevator cars.

9. The system of claim 1, wherein:
the controller renders the first determination from the travel time to respond to the service request; and
upon the controller determining that the elevator cars will respond to the service request within a same period of time, the controller is configured to render a second determination to select the one of the elevator cars to respond to the service request; and
the controller is configured to render the second determination from the elevator health and usage state.

10. The system of claim 9, wherein:
upon the controller determining that the elevator health and usage state are the same for each of the elevator cars, the controller is configured to render a third decision to select the one of the elevator cars to respond to the service request from a round-robin sequence assigned to the elevator cars.

11. A method of operation an elevator system in a building having elevator cars, a controller operationally coupled to the elevator cars, and a plurality of levels serviced by the elevator cars, the method comprising the controller:
receiving a service request; and
rendering a first determination to select one of the elevator cars to respond to the service request,
wherein the first determination includes the controller determining one or more of an elevator health and usage state of the elevator cars, and a travel time to respond to the service request for each of the elevator cars.

12. The method of claim 11, further comprising the controller
determining the travel time for each of the elevator cars by utilizing one or more travel time factors, including one or more of:
a current car position of each of the elevator cars;
a direction of motion of each of the elevator cars;
a door open and closed state of each of the elevator cars;
a number of intermediate stops assigned to each of the elevator cars; and
a number of calls assigned to each of the elevator cars and a number of passengers served by each of the elevator cars.

13. The method of claim 11, further comprising the controller
determining the elevator health and usage state of the elevator cars by utilizing one or more health and usage factors, including a health index and diagnostic information, including one or more of:
a number of times elevator doors have opened and closed for each of the elevator cars;
accumulated bends per segment of elevator tension members around elevator sheaves;
a charge state and health of on-board batteries for each of the elevator cars;
energy utilization from operation of each of the elevator cars;
an operating temperature of elevator components for each of the elevator cars;
a number of machine starts of the elevator machines for each of the elevator cars;
maintenance records for each of the elevator cars;
a remaining lifespan of components of each of the elevator cars, including the tension members attached to each of the elevator cars; and
ride quality for each of the elevator cars, including noise and vibration.

14. The method of claim 13, further comprising the controller:
applying a weighting to the health and usage factors, including the health index and diagnostic information, to determine a score for each of the elevator cars; and
selecting the one of the elevator cars to respond to the service request from the score determined for each of the elevator cars.

15. The method of claim 14, further comprising the controller:
controlling an ongoing operation of the elevator cars from the score determined for each of the elevator cars, which includes one or more of:
utilizing the elevator cars to balance the health and usage scores for each elevator car; and
reducing a utilization or speed of one or more of the elevator cars when the score is above a first threshold; or
increasing the usage of one or more of the elevator cars when the score is above a second threshold.

16. The method of claim 11, wherein:
sensors are located on one or more of the elevator cars and elevator machines, operationally coupled to the controller and configured to capture sensor data during operation of the elevator cars and machines and transmit the sensor data to the controller, and
the method includes the controller utilizing the sensor data when analyzing the elevator health and usage state for the elevator cars.

17. The method of claim 11, wherein
upon completing the service request by the one of the elevator cars, the method includes the controller updating the elevator health and usage state for the one of the elevator cars.

18. The method of claim 11, wherein
following maintenance of the elevator cars, the method includes the controller updating the elevator health and usage state for the elevator cars.

19. The method of claim 11, further comprising the controller:
rendering the first determination from the travel time to respond to the service request; and
determining that the elevator cars will respond to the service request within a same period of time, and rendering a second determination to select the one of the elevator cars to respond to the service request; and
rendering the second determination from the elevator health and usage state.

20. The method of claim 19, further comprising the controller:
determining that the elevator health and usage state are the same for each of the elevator cars; and
rendering a third decision to select the one of the elevator cars to respond to the service request from a round-robin sequence assigned to the elevator cars.
